(19) United States
(12) Patent Application Publication
(10) Pub. No.: US 2026/0185616 A1
(43) Pub. Date: Jul. 2, 2026

(54) BALL VALVE HOSE BIB DEVICE

(71) Applicant: Amos Garber, Dalton, OH (US)

(72) Inventor: Amos Garber, Dalton, OH (US)

(21) Appl. No.: 19/002,087

(22) Filed: Dec. 26, 2024

(51) Int. Cl. F16K 5/06; F16K 31/53

(52) U.S. Cl. CPC F16K 5/0647; F16K 31/535

(57) ABSTRACT

A ball valve hose bib device for maximizing a flow of water includes a wall plate that is mountable to an exterior wall of a building. A hose bib extends through the wall plate and the hose bib is coupled to a water source. A ball valve is rotatably integrated into the hose bib and the ball valve is positionable in a closed position or an open position. A rod extends through the wall plate and the rod is in mechanical communication with the ball valve. The rod urges the ball valve into the open position when the rod is rotated in an opening direction. Conversely, the rod urges the ball valve into the closed position when the rod is rotated in a closing direction. A knob is attached to the rod and the knob can be gripped by a user.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to hose bib devices and more particularly pertains to a new hose bib device for maximizing a flow of water. The device includes a wall plate that is mountable to an exterior wall of a building and a hose bib that extends through the wall plate which is coupled to a water source. The device includes a ball valve that is integrated into the hose bib and a rod that extends through the wall plate which his in mechanical communication with the ball valve for opening or closing the ball valve. The device includes a knob attached to the rod which can be gripped for rotating the rod to open or close the ball valve.

### (2) Description of Related Art Including Information Disclosed Under 37 CFR 1.97 and 1.98

The prior art relates to hose bib devices including: a variety of hose bib devices that each at least includes a hose bib and a rod extending through the hose bib that is in mechanical communication with a valve inside of the hose bib for opening or closing the valve; a variety of hose bib devices that each at least includes a hose bib and a ball valve integrated into the hose bib for controlling a flow of water through the hose bib and a lever in mechanical communication with the ball valve; a sprinkler winterization device that includes a valve located within a building and a rod which extends through an exterior wall of the building which is in mechanical communication with the valve to open or close the valve. In no instance does the prior art disclose a ball valve hose bib device that includes a wall plate mounted to an exterior wall of a building and a hose bib extending through the wall plate and a ball valve integrated into the hose bib and a rod extending through the wall plate which is in mechanical communication with the ball valve to open or close the ball valve.

### (h) BRIEF SUMMARY OF THE INVENTION

An embodiment of the disclosure meets the needs presented above by generally comprising a wall plate that is mountable to an exterior wall of a building. A hose bib extends through the wall plate and the hose bib is coupled to a water source. A ball valve is rotatably integrated into the hose bib and the ball valve is positionable in a closed position or an open position. A rod extends through the wall plate and the rod is in mechanical communication with the ball valve. The rod urging the ball valve into the open position when the rod is rotated in an opening direction. Conversely, the rod urges the ball valve into the closed position when the rod is rotated in a closing direction. A knob is attached to the rod and the knob can be gripped by a user.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a ball valve hose bib device according to an embodiment of the disclosure.

FIG. 2 is a front view of an embodiment of the disclosure.

FIG. 3 is a cross sectional view taken along line 3-3 of FIG. 2 of an embodiment of the disclosure showing a ball valve in a closed position.

FIG. 4 is a cross sectional view taken along line 4-4 of FIG. 2 of an embodiment of the disclosure showing a ball valve in an open position.

### (j) DETAILED DESCRIPTION OF THE INVENTION

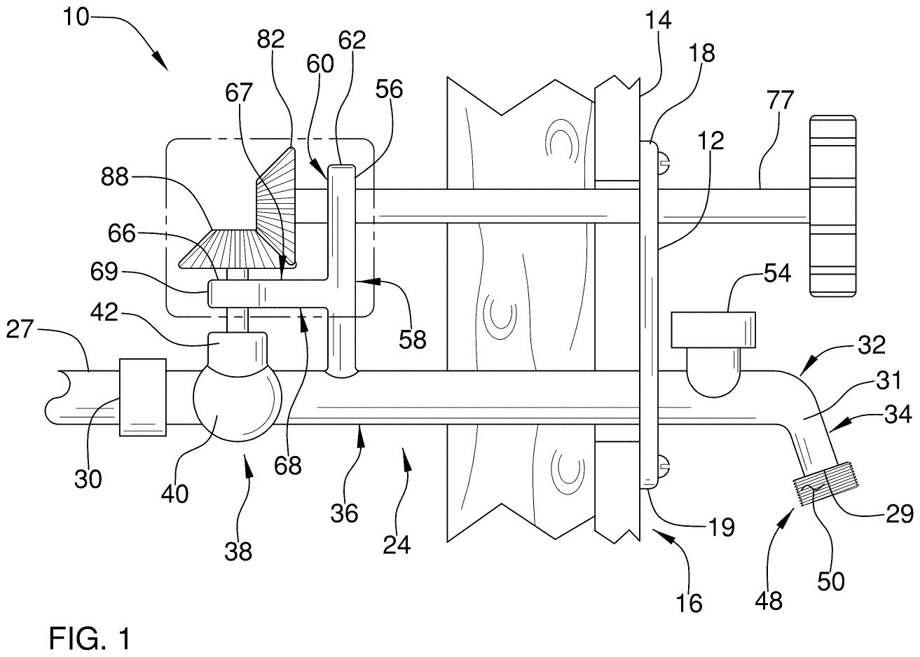

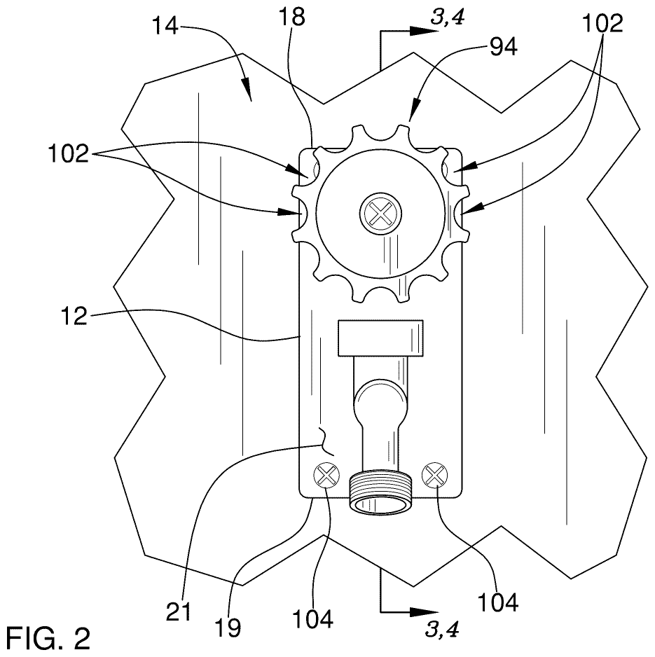

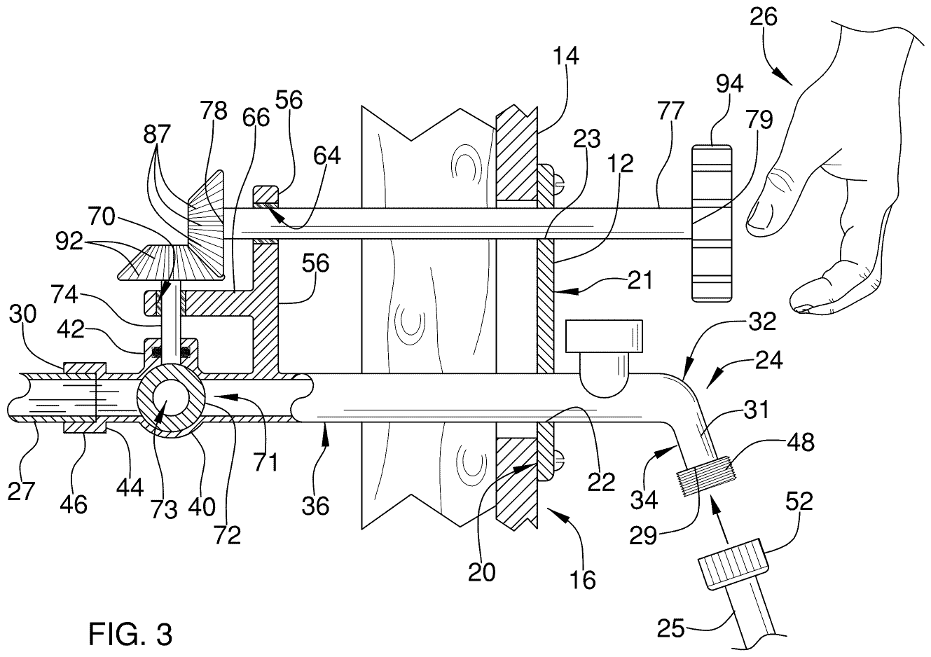

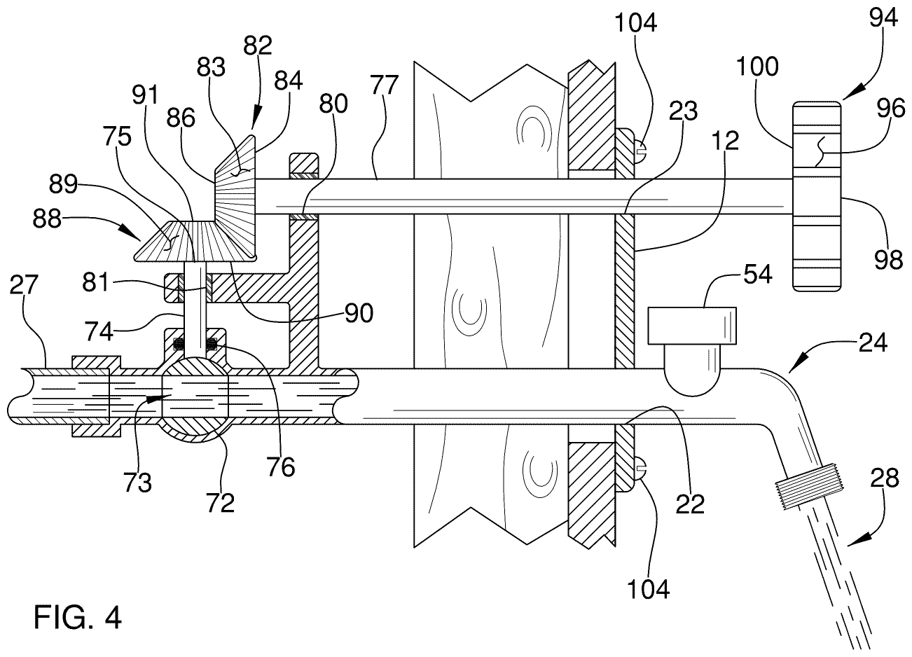

With reference now to the drawings, and in particular to FIGS. 1 through 4 thereof, a new hose bib device embodying the principles and concepts of an embodiment of the disclosure and generally designated by the reference numeral 10 will be described.

As best illustrated in FIGS. 1 through 4, the ball valve hose bib device 10 generally comprises a wall plate 12 that is mountable to an exterior wall 14 of a building 16. The building 16 may be a house, an apartment or other type of dwelling. The wall plate 12 has top edge 18 and a bottom edge 19; the wall plate 12 has a back surface 20 extending between the top edge 18 and the bottom edge 19 and the wall plate 12 has a front surface 21 extending between the top edge 18 and the bottom edge 19. Furthermore, the wall plate 12 has a first hole 22 extending through the front surface 21 and the back surface 20 and the first hole 22 is positioned closer to the bottom edge 19 than the top edge 18. The wall plate 12 has a second hole 23 extending through the front surface 21 and the back surface 20 and the second hole 23 is positioned closer to the top edge 18 than the bottom edge 19. Additionally, the second hole 23 is aligned with the first hole 22.

A hose bib 24 extends through the wall plate 12 such that the hose bib 24 extends through the exterior wall 14 of the building 16. Moreover, the hose bib 24 can be coupled to a hose 25 by a user 26 who is located outside of the building 16. The hose bib 24 is coupled to a water source 27 such that the hose bib 24 receives water 28 from the water source 27 to direct the water 28 into the hose 25. The water source 27 may be a water pipe of a plumbing system of the building 16 and the hose 25 may be a garden hose or the like. The hose bib 24 has a first end 29 and a second end 30 and an outer wall 31 extending between the first end 29 and the second end 30; the outer wall 31 extends through the first hole 22 in the wall plate 12 having the first end 29 being located outside of the building 16 and having the second end 30 being located within the building 16. Furthermore, the second end 30 is fluidly coupled to the water source 27.

The outer wall 31 has a bend 32 which defines a first portion 34 of the outer wall 31 that is oriented at an angle with a second portion 36 of the outer wall 31 and the bend 32 is located closer to the first end 29 than the second end 30. The first portion 34 is associated with the first end 29 and the second portion 36 is associated with the second end 30. Furthermore, the hose bib 24 has a valve housing 38 which is integrated into the outer wall 31. The valve housing 38 has a rounded portion 40 which is continuously arcuate about a center point of the valve housing 38 such that the rounded portion 40 has a spherical shape. Additionally, the valve housing 38 has a conduit portion 42 extending upwardly from the rounded portion 40. The valve housing 38 is located on the second portion 36 of the outer wall 31 and the valve housing 38 is positioned closer to the second end 30 than the bend 32 such that the valve housing 38 is located within the building 16 to protect the valve housing 38 from freezing temperatures outside of the building 16.

The outer wall 31 has a first section 44 which is oriented perpendicular to the second portion 36 of the outer wall 31. Additionally, the outer wall 31 has a second section 46 that is oriented perpendicular to the first section 44 such that the second section 46 is oriented parallel to the second portion 36 of the outer wall 31. The second section 46 extends between the second end 30 of the hose bib 24 and the first section 44. Furthermore, the second section 46 has a diameter which is greater than a diameter of the second portion 36 of the outer wall 31 such that the second section 46 insertably receives the water source 27.

The hose bib 24 has a coupler 48 that is attached to the first end 29 of the hose bib 24 and the coupler 48 has an outer surface 50 is threaded such that the outer surface 50 can be threadably coupled to a hose coupler 52 on the hose 25. The hose bib 24 is oriented in the wall plate 12 such that the first portion 34 angles downwardly with respect to the wall plate 12 such that the first portion 34 directs the water 28 to flow downwardly into the hose 25 when the hose coupler 52 is threadably coupled to the outer surface 50 of the coupler 48. The hose bib 24 has a pressure relief port 54 which is integrated into the outer wall 31 and the pressure relief port 54 is positioned between the bend 32 and the wall plate 12 such that the pressure relief port 54 is accessible to the user 26. The pressure relief port 54 is in fluid communication with an interior of the hose bib 24 such that the pressure relief port 54 can relieve pressure that has built up within the hose bib 24 and the hose 25 to enable the hose coupler 52 to be disconnected from the outer surface 50 of the coupler 48.

A first plate 56 is coupled to and extends away from the outer wall 31 of the hose bib 24 having the first plate 56 being oriented perpendicular to a lengthwise axis of the second portion 36 of the outer wall 31 of the hose bib 24 which extends between the second end 30 of the hose bib 24 and the bend 32 in the outer wall 31. The first plate 56 has a forward surface 58 and a rear surface 60 and an upper edge 62; the first plate 56 has a hole 64 extending through the rear surface 60 and the forward surface 58 and the hole 64 is located closer to the upper edge 62 than the outer wall 31 of the hose bib 24. A second plate 66 is coupled to and extends away from the rear surface 60 of the first plate 56 having the second plate 66 lying on a plane that is oriented perpendicular to the rear surface 60. The second plate 66 has a top surface 67 and a bottom surface 68 and a rear edge 69 and the second plate 66 has a hole 70 extending through the top surface 67 and the bottom surface 68. Furthermore, the hole 70 in the second plate 66 is positioned closer to the rear edge 69 than the rear surface 60 of the first plate 56 having the hole 70 in the second plate 66 being aligned with the conduit portion 42 of the valve housing 38.

A ball valve 71 is rotatably integrated into the hose bib 24 and the ball valve 71 is located on the hose bib 24 such that the ball valve 71 is located within the building 16 such that the ball valve 71 is protected from freezing temperatures outside of the building 16. The ball valve 71 is positionable in a closed position such that the ball valve 71 inhibits the water 28 from flowing through the hose bib 24. Conversely, the ball valve 71 is positionable in an open position such that the ball valve 71 allows the water 28 to flow through the hose bib 24. The ball valve 71 comprises a ball 72 that is rotatably positioned within the rounded portion 40 of the valve housing 38 and the ball 72 has a channel 73 extending through the ball valve 71. The ball 72 is rotatable into a first position having the channel 73 being oriented to extend along a line that is colinear with the lengthwise axis extending between the second end 30 of the hose bib 24 and the bend 32 such that the water 28 can flow through the channel 73 when the ball valve 71 is in the open position. Conversely, the ball 72 is rotatable into a second position having the channel 73 being offset with respect to the lengthwise axis thereby inhibiting the water 28 from flowing through the channel 73 when the ball valve 71 is in the closed position.

The ball valve 71 includes a stem 74 that is coupled to and extends upwardly from the ball 72 having the stem 74 extending through the conduit portion 42 of the valve housing 38. Additionally, the stem 74 extends through the hole 70 in the second plate 66 and the stem 74 has a top end 75 which is spaced upwardly from the top surface 67 of the second plate 66. The ball valve 71 includes an annular gasket 76 that is located within the conduit portion 42 of the valve housing 38 and the stem 74 extends through the annular gasket 76. The annular gasket 76 is comprised of a resiliently compressible material, including but not being limited to rubber or silicone, such that the annular gasket 76 forms a fluid impermeable seal with the stem 74 thereby inhibiting the water 28 from flowing between the annular gasket 76 and the stem 74.

A rod 77 extends through the wall plate 12 and the rod 77 is in mechanical communication with the ball valve 71. The rod 77 urges the ball valve 71 into the open position when the rod 77 is rotated in an opening direction. Conversely, the rod 77 urges the ball valve 71 into the closed position when the rod 77 is rotated in a closing direction. The rod 77 has a primary end 78 and a secondary end 79; the rod 77 extends through the second hole 23 in the wall plate 12 such that the primary end 78 is located outside of the building 16 and the secondary end 79 is located within the building 16. Furthermore, the rod 77 extends through the hole 64 in the first plate 56 having the secondary end 79 being spaced from the rear surface 60 of the first plate 56.

A first annular bushing 80 is located within the hole 64 in the first plate 56 such that the rod 77 extends through the first annular bushing 80. Additionally, the first annular bushing 80 is comprised of a friction reducing material, including but not being limited to nylon or plastic, to reduce friction between the rod 77 and the first annular bushing 80. A second annular bushing 81 is located within the hole 70 in the second plate 66 such that the stem 74 extends through the second annular bushing 81. The second annular bushing 81 is comprised of a friction reducing material, including but not being limited to nylon or plastic, to reduce friction between the stem 74 and the second bushing.

A first gear 82 is provided which has an engaging surface 83 that slopes between a coupled surface 84 of the first gear 82 and a free surface 86 of the first gear 82; the coupled surface 84 is coupled to the secondary end 79 of the rod 77. The first gear 82 has a plurality of first teeth 87 integrated into the engaging surface 83 having the plurality of first teeth 87 being evenly distributed around the engaging surface 83. Additionally, the plurality of first teeth 87 extends between the coupled surface 84 and the free surface 86. A second gear 88 is provided which has an engaging surface 89 sloping between a coupled surface 90 of the second gear 88 and a free surface 91 of the second gear 88; the coupled surface 90 of the second gear 88 is coupled to the top end 75 of the stem 74.

The second gear 88 has a plurality of second teeth 92 integrated into the engaging surface 89 of the second gear 88 having the plurality of second teeth 92 being evenly distributed around the engaging surface 89 of the second gear 88. Furthermore, the plurality of second teeth 92 extends between the coupled surface 90 of the second gear 88 and the free surface 91 of the second gear 88. The plurality of first teeth 87 enmesh with the plurality of second teeth 92 such that the second gear 88 has a rotational axis which is perpendicular to a rotational axis of the first gear 82. The first gear 82 rotates the second gear 88 when the rod 77 is rotated and the second gear 88 rotates the stem 74 when the first gear 82 rotates the second gear 88. Furthermore, the stem 74 rotates the ball 72 into the first position when the rod 77 is rotated in the opening direction and the stem 74 rotates the ball 72 into the second position when the rod 77 is rotated in the closing direction.

A knob 94 is attached to the rod 77 having the knob 94 being located outside of the building 16 such that the knob 94 can be gripped by the user 26. The knob 94 has an exterior surface 96 extending between a forward surface 98 of the knob 94 and a rearward surface 100 and the rearward surface 100 is coupled to secondary end 79 of the rod 77. The exterior surface 96 has a plurality of concave depressions 102 evenly spaced apart from each other and being distributed around a full circumference of the exterior surface 102 to enhance the user's grip 26 on the exterior surface 96. Conventional hose bibs typically have a rod that is located within the conventional hose bib which can inhibit the flow of water through the conventional hose bib in the event of reduced water pressure. By positioning the rod 77 outside of the hose bib 24, as is described in the aforementioned disclosure, the rod 77 does not impede the flow of water 28 through the hose bib 24 thereby facilitating an adequate volume of water 28 to flow through the hose bib 24 for watering a lawn or washing a vehicle, even in the event that the water pressure supplied from the water source 27 is less than optimal.

In use, the wall plate 12 is mounted to the exterior wall 14 of the building 16 and the second end 30 of the hose bib 24 is coupled to the water source 27. As is shown in FIGS. 1, 3 and 4, fasteners 104 are extended through the wall plate 12 to fasten the wall plate 12 to the exterior wall 14. The hose coupler 52 on the hose 25 is attached to the coupler 48 on the first end 29 of the hose bib 24. The knob 94 is gripped to rotate the rod 77 in the opening direction to position the ball valve 71 in the open position such that the water 28 can flow through the hose bib 24 and through the hose 25. The knob 94 is gripped to rotate the rod 77 in the closing direction to position the ball valve 71 in the closed position thereby ceasing the flow of water 28 through the hose bib 24.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A ball valve hose bib device for maximizing a flow rate of water that is available to a hose, said device comprising:
a wall plate being mountable to an exterior wall of a building;
a hose bib extending through said wall plate such that said hose bib extends through said exterior wall of said building wherein said hose bib is configured to be coupled to a hose by a user who is located outside of said building, said hose bib being coupled to a water source such that said hose bib receives water from said water source wherein said hose bib is configured to direct said water into the hose;
a ball valve being rotatably integrated into said hose bib, said ball valve being located on said hose bib such that said ball valve is located within said building wherein said ball valve is configured to be protected from freezing temperatures outside of said building, said ball valve being positionable in a closed position such that said ball valve inhibits said water from flowing through said hose bib, said ball valve being positionable in an open position such that said ball valve allows said water to flow through said hose bib;
a rod extending through said wall plate, said rod being in mechanical communication with said ball valve, said rod urging said ball valve into said open position when said rod is rotated in an opening direction, said rod urging said ball valve into said closed position when said rod is rotated in a closing direction; and
a knob being attached to said rod having said knob being located outside of said building wherein said knob is configured to be gripped by the user.

2. The ball valve hose bib device according to claim 1, wherein:
said wall plate has top edge and a bottom edge;
said wall plate has a back surface extending between said top edge and said bottom edge;
said wall plate has a front surface extending between said top edge and said bottom edge;
said wall plate has a first hole extending through said front surface and said back surface;
said first hole is positioned closer to said bottom edge than said top edge;
said wall plate has a second hole extending through said front surface and said back surface;
said second hole is positioned closer to said top edge than said bottom edge; and
said second hole is aligned with said first hole.

3. The ball valve hose bib device according to claim 2, wherein:
said hose bib has a first end and a second end and an outer wall extending between said first end and said second end;
said outer wall extends through said first hole in said wall plate having said first end being located outside of said building and having said second end being located within said building;
said second end is fluidly coupled to said water source;
said outer wall has a bend defining a first portion of said outer wall being oriented at an angle with a second portion of said outer wall;
said bend is located closer to said first end than said second end;
said first portion is associated with said first end;
said second portion is associated with said second end;
said hose bib has a valve housing being integrated into said outer wall;
said valve housing has a rounded portion being continuously arcuate about a center point of said valve housing such that said rounded portion has a spherical shape;
said valve housing has a conduit portion extending upwardly from said rounded portion;
said valve housing is located on said second portion of said outer wall; and
said valve housing is positioned closer to said second end than said bend such that said valve housing is located within said building wherein said valve housing is configured to be protected from freezing temperatures outside of said building.

4. The ball valve hose bib device according to claim 3, wherein:
said ball valve hose bib device includes a first plate being coupled to and extending away from said outer wall of said hose bib having said first plate being oriented perpendicular to a lengthwise axis of said second portion of said outer wall of said hose bib which extends between said second end of said hose bib and said bend in said outer wall;
said first plate has a forward surface and a rear surface and an upper edge;
said first plate has a hole extending through said rear surface and said forward surface; and
said hole is located closer to said upper edge than said outer wall of said hose bib.

5. The ball valve hose bib device according to claim 4, wherein:
said ball valve hose bib device includes a second plate being coupled to and extending away from said rear surface of said first plate having said second plate lying on a plane being oriented perpendicular to said rear surface;
said second plate has a top surface and a bottom surface and a rear edge;
said second plate has a hole extending through said top surface and said bottom surface; and
said hole in said second plate is positioned closer to said rear edge than said rear surface of said first plate having said hole in said second plate being aligned with said conduit portion of said valve housing.

6. The ball valve hose bib device according to claim 3, wherein:
said ball valve includes a ball being rotatably positioned within said rounded portion of said valve housing;
said ball has a channel extending through said ball valve;
said ball is rotatable into a first position having said channel being oriented to extend along a line being colinear with said lengthwise axis extending between said second end of said hose bib and said bend such that said water can flow through said channel when said ball valve is in said open position; and
said ball is rotatable into a second position having said channel being offset with respect to said lengthwise axis thereby inhibiting said water from flowing through said channel when said ball valve is in said closed position.

7. The ball valve hose bib device according to claim 5, wherein:
said ball valve includes a ball;
said ball valve includes a stem being coupled to and extending upwardly from said ball;
said stem extends through said conduit portion of said valve housing;
said stem extends through said hole in said second plate; and
said stem having a top end being spaced upwardly from said top surface of said second plate.

8. The ball valve hose bib device according to claim 7, wherein:
said ball valve hose bib device includes an annular gasket being located within said conduit portion of said valve housing;
said stem extends through said annular gasket; and
said annular gasket is comprised of a resiliently compressible material such that said annular gasket forms a fluid impermeable seal with said stem thereby inhibiting said water from flowing between said annular gasket and said stem.

9. The ball valve hose bib device according to claim 4, wherein:
said rod has a primary end and a secondary end;
said rod extends through said second hole in said wall plate such that said primary end is located outside of said building and said secondary end is located within said building; and
said rod extends through said hole in said first plate having said secondary end being spaced from said rear surface of said first plate.

10. The ball valve hose bib device according to claim 4, wherein:
said ball valve hose bib device includes a first annular bushing being located within said hole in said first plate such that said rod extends through said first annular bushing; and
said first annular bushing is comprised of a friction reducing material to reduce friction between said rod and said first annular bushing.

11. The ball valve hose bib device according to claim 7, wherein:
said ball valve hose bib device includes a first annular bushing;
said ball valve hose bib device includes a second annular bushing being located within said hole in said second plate such that said stem extends through said second annular bushing;
said second annular bushing being comprised of a friction reducing material to reduce friction between said stem and said second bushing.

12. The ball valve hose bib device according to claim 9, wherein:
said ball valve hose bib device includes a first gear having an engaging surface sloping between a coupled surface of said first gear and a free surface of said first gear;
said coupled surface is coupled to said secondary end of said rod;
said first gear has a plurality of first teeth being integrated into said engaging surface having said plurality of first teeth being evenly distributed around said engaging surface; and
said plurality of first teeth extends between said coupled surface and said free surface.

13. The ball valve hose bib device according to claim 7, wherein
said ball valve hose bib device includes a first gear;
said first gear having a plurality of first teeth;
said device includes a second gear having an engaging surface sloping between a coupled surface of said second gear and a free surface of said second gear;
said coupled surface of said second gear is coupled to said top end of said stem;
said second gear has a plurality of second teeth being integrated into said engaging surface of said second gear having said plurality of second teeth being evenly distributed around said engaging surface of said second gear;
said plurality of second teeth extends between said coupled surface of said second gear and said free surface of said second gear;
said plurality of first teeth enmeshes with said plurality of second teeth such that said second gear has a rotational axis being perpendicular to a rotational axis of said first gear; and
said first gear rotates said second gear when said rod is rotated.

14. The ball valve hose bib device according to claim 13, wherein:
said second gear rotates said stem when said first gear rotates said second gear;
said stem rotates said ball into a first position when said rod is rotated in said opening direction; and
said stem rotates said ball into a second position when said rod is rotated in said closing direction.

15. The ball valve hose bib device according to claim 9, wherein:
said knob has an exterior surface extending between a forward surface of said knob and a rearward surface;
said rearward surface is coupled to secondary end of said rod; and
said exterior surface has a plurality of concave depressions being evenly spaced apart from each other and being distributed around a full circumference of said exterior surface wherein said plurality of concave depressions is configured to enhance the user's grip on said exterior surface.

16. A ball valve hose bib device for maximizing a flow rate of water that is available to a hose, said device comprising:
a wall plate being mountable to an exterior wall of a building, said wall plate having top edge and a bottom edge, said wall plate having a back surface extending between said top edge and said bottom edge, said wall plate having a front surface extending between said top edge and said bottom edge, said wall plate having a first hole extending through said front surface and said back surface, said first hole being positioned closer to said bottom edge than said top edge, said wall plate having a second hole extending through said front surface and said back surface, said second hole being positioned closer to said top edge than said bottom edge, said second hole being aligned with said first hole;
a hose bib extending through said wall plate such that said hose bib extends through said exterior wall of said building wherein said hose bib is configured to be coupled to a hose by a user who is located outside of said building, said hose bib being coupled to a water source such that said hose bib receives water from said water source wherein said hose bib is configured to direct said water into the hose, said hose bib having a first end and a second end and an outer wall extending between said first end and said second end, said outer wall extending through said first hole in said wall plate having said first end being located outside of said building and having said second end being located within said building, said second end being fluidly coupled to said water source, said outer wall having a bend defining a first portion of said outer wall being oriented at an angle with a second portion of said outer wall, said bend being located closer to said first end than said second end, said first portion being associated with said first end, said second portion being associated with said second end, said hose bib having a valve housing being integrated into said outer wall, said valve housing having a rounded portion being continuously arcuate about a center point of said valve housing such that said rounded portion has a spherical shape, said valve housing having a conduit portion extending upwardly from said rounded portion, said valve housing being located on said second portion of said outer wall, said valve housing being positioned closer to said second end than said bend such that said valve housing is located within said building wherein said valve housing is configured to be protected from freezing temperatures outside of said building, said outer wall having a first section being oriented perpendicular to said second portion of said outer wall, said outer wall having a second section being oriented perpendicular to said first section such that said second section is oriented parallel to said second portion of said outer wall, said second section extending between said second end of said hose bib and said first section, said second section having a diameter being greater than a diameter of said second portion of said outer wall such that said second section insertably receives said water source, said hose bib having a coupler being attached to said first end of said hose bib, said coupler having an outer surface being threaded wherein said outer surface is configured to be threadably coupled to a hose coupler on the hose, said hose bib being oriented in said wall plate such that said first portion angles downwardly with respect to said wall plate wherein said first portion is configured to direct said water to flow downwardly into the hose when the hose coupler is threadably coupled to said outer surface of said coupler, said hose bib having a pressure relief port being integrated into said outer wall, said pressure relief port being positioned between said bend and said wall plate wherein said pressure relief port is configured to be accessible to the user;
a first plate being coupled to and extending away from said outer wall of said hose bib having said first plate being oriented perpendicular to a lengthwise axis of said second portion of said outer wall of said hose bib which extends between said second end of said hose bib and said bend in said outer wall, said first plate having a forward surface and a rear surface and an upper edge, said first plate having a hole extending through said rear surface and said forward surface, said hole being located closer to said upper edge than said outer wall of said hose bib;
a second plate being coupled to and extending away from said rear surface of said first plate having said second plate lying on a plane being oriented perpendicular to said rear surface, said second plate having a top surface and a bottom surface and a rear edge, said second plate having a hole extending through said top surface and said bottom surface, said hole in said second plate being positioned closer to said rear edge than said rear surface of said first plate having said hole in said second plate being aligned with said conduit portion of said valve housing;
a ball valve being rotatably integrated into said hose bib, said ball valve being located on said hose bib such that said ball valve is located within said building wherein said ball valve is configured to be protected from freezing temperatures outside of said building, said ball valve being positionable in a closed position such that said ball valve inhibits said water from flowing through said hose bib, said ball valve being positionable in an open position such that said ball valve allows said water to flow through said hose bib, said ball valve comprising:
a ball being rotatably positioned within said rounded portion of said valve housing, said ball having a channel extending through said ball valve, said ball being rotatable into a first position having said channel being oriented to extend along a line being colinear with said lengthwise axis extending between said second end of said hose bib and said bend such that said water can flow through said channel when said ball valve is in said open position, said ball being rotatable into a second position having said channel being offset with respect to said lengthwise axis thereby inhibiting said water from flowing through said channel when said ball valve is in said closed position;
a stem being coupled to and extending upwardly from said ball, said stem extending through said conduit portion of said valve housing, said stem extending through said hole in said second plate, said stem having a top end being spaced upwardly from said top surface of said second plate; and
an annular gasket being located within said conduit portion of said valve housing, said stem extending through said annular gasket, said annular gasket being comprised of a resiliently compressible material such that said annular gasket forms a fluid impermeable seal with said stem thereby inhibiting said water from flowing between said annular gasket and said stem;
a rod extending through said wall plate, said rod being in mechanical communication with said ball valve, said rod urging said ball valve into said open position when said rod is rotated in an opening direction, said rod urging said ball valve into said closed position when said rod is rotated in a closing direction, said rod having a primary end and a secondary end, said rod extending through said second hole in said wall plate such that said primary end is located outside of said building and said secondary end is located within said building, said rod extending through said hole in said first plate having said secondary end being spaced from said rear surface of said first plate;
a first annular bushing being located within said hole in said first plate such that said rod extends through said first annular bushing, said first annular bushing being comprised of a friction reducing material to reduce friction between said rod and said first annular bushing;
a second annular bushing being located within said hole in said second plate such that said stem extends through said second annular bushing, said second annular bushing being comprised of a friction reducing material to reduce friction between said stem and said second bushing;
a first gear having an engaging surface sloping between a coupled surface of said first gear and a free surface of said first gear, said coupled surface being coupled to said secondary end of said rod, said first gear having a plurality of first teeth being integrated into said engaging surface having said plurality of first teeth being evenly distributed around said engaging surface, said plurality of first teeth extending between said coupled surface and said free surface;
a second gear having an engaging surface sloping between a coupled surface of said second gear and a free surface of said second gear, said coupled surface of said second gear being coupled to said top end of said stem, said second gear having a plurality of second teeth being integrated into said engaging surface of said second gear having said plurality of second teeth being evenly distributed around said engaging surface of said second gear, said plurality of second teeth extending between said coupled surface of said second gear and said free surface of said second gear, said plurality of first teeth enmeshing with said plurality of second teeth such that said second gear has a rotational axis being perpendicular to a rotational axis of said first gear, said first gear rotating said second gear when said rod is rotated, said second gear rotating said stem when said first gear rotates said second gear, said stem rotating said ball into said first position when said rod is rotated in said opening direction, said stem rotating said ball into said second position when said rod is rotated in said closing direction; and
a knob being attached to said rod having said knob being located outside of said building wherein said knob is configured to be gripped by the user, said knob having an exterior surface extending between a forward surface of said knob and a rearward surface, said rearward surface being coupled to secondary end of said rod, said exterior surface having a plurality of concave depressions being evenly spaced apart from each other and being distributed around a full circumference of said exterior surface wherein said plurality of concave depressions is configured to enhance the user's grip on said exterior surface.
